(19) United States
(12) Patent Application Publication
(10) Pub. No.: US 2019/0148080 A1
(43) Pub. Date: May 16, 2019

(54) ELECTROLYTIC CAPACITOR AND PRODUCTION METHOD THEREOF

(71) Applicant: Panasonic Intellectual Property Management Co., Ltd., Osaka (JP)

(72) Inventors: HITOSHI FUKUI, Nara (JP); SHINYA SUZUKI, Kyoto (JP); KOJI OKAMOTO, Kyoto (JP); MAKOTO NAGASHIMA, Kyoto (JP)

(21) Appl. No.: 16/243,140

(22) Filed: Jan. 9, 2019

Related U.S. Application Data
(63) Continuation of application No. PCT/JP2017/024931, filed on Jul. 7, 2017.

(30) Foreign Application Priority Data
Jul. 29, 2016 (JP) 2016-150854

(51) Int. Cl. H01G 9/028; H01G 9/15; H01G 9/00

(52) U.S. Cl. CPC H01G 9/028; H01G 9/052; H01G 9/0036; H01G 9/15

(57) ABSTRACT

An electrolytic capacitor includes an anode body, a dielectric layer disposed on the anode body, and a solid electrolyte layer disposed on the dielectric layer. The solid electrolyte layer includes a first conductive polymer layer, a second conductive polymer layer, and a third conductive polymer layer that are disposed in this order from the dielectric layer. The first conductive polymer layer contains a first conductive polymer having a thiophene skeleton. The second conductive polymer layer contains a second conductive polymer having at least one of an aniline skeleton and a pyrrole skeleton. The third conductive polymer layer contains a third conductive polymer having a thiophene skeleton.

### RELATED APPLICATIONS

This application is a continuation of the PCT International Application No. PCT/JP2017/024931 filed on Jul. 7, 2017, which claims the benefit of foreign priority of Japanese patent application No. 2016-150854 filed on Jul. 29, 2016, the contents all of which are incorporated herein by reference.

### BACKGROUND

### 1. Technical Field

The present disclosure relates to an electrolytic capacitor having a solid electrolyte layer containing a conductive polymer, and a production method thereof.

### 2. Description of the Related Art

As small-sized, large capacitance, and low equivalent series resistance (ESR) capacitors, promising candidates are electrolytic capacitors containing an anode body with a dielectric layer formed thereon and a solid electrolyte layer formed so as to cover at least a part of the dielectric layer. The solid electrolyte layer contains a conductive polymer such as a π-conjugated polymer.

An electrolytic capacitor including a solid electrolyte layer having a plurality of conductive polymer layers that are sequentially formed has been proposed to improve performance of the electrolytic capacitor. Japanese Translation of PCT International Application Publication No. JP-T-2002-524593 discloses that in formation of an electrolytic capacitor, an anode body subjected to an anodizing treatment is immersed in a solution containing a monomer (3,4-ethylenedioxythiophene) for a conductive polymer, an oxidant and so on, the monomer is polymerized to form a conductive polymer layer containing a poly(3,4-ethylenedioxythiophene) (hereinafter referred to as PEDOT), and subsequently another conductive polymer layer is formed thereon by using a dispersion liquid containing a PEDOT.

### SUMMARY

An electrolytic capacitor according to a first aspect of the present disclosure includes an anode body, a dielectric layer disposed on the anode body, and a solid electrolyte layer disposed on the dielectric layer. The solid electrolyte layer includes a first conductive polymer layer, a second conductive polymer layer, and a third conductive polymer layer that are disposed in this order from the dielectric layer. The first conductive polymer layer contains a first conductive polymer having a thiophene skeleton. The second conductive polymer layer contains a second conductive polymer having at least one of an aniline skeleton and a pyrrole skeleton. The third conductive polymer layer contains a third conductive polymer having a thiophene skeleton.

Further, an electrolytic capacitor according to a second aspect of the present disclosure includes an anode body, a dielectric layer disposed on the anode body, and a solid electrolyte layer disposed on the dielectric layer. The solid electrolyte layer includes a first conductive polymer layer, a second conductive polymer layer, and a third conductive polymer layer that are disposed in this order from the dielectric layer. The first conductive polymer layer contains a first conductive polymer having a thiophene skeleton. The second conductive polymer layer contains a second conductive polymer. The third conductive polymer layer contains a third conductive polymer having a thiophene skeleton. The second conductive polymer layer is lower in shrinkage rate at a time of voltage application than the first conductive polymer layer and the third conductive polymer layer.

A method for producing an electrolytic capacitor according to a third aspect of the present disclosure includes following first to third steps. In a first step, a first conductive polymer having a thiophene skeleton is adhered to an anode body on which a dielectric layer is formed by bringing a first treatment liquid containing the first conductive polymer into contact with the anode body. In a second step, after the first step, a second conductive polymer having at least one of an aniline skeleton and a pyrrole skeleton is adhered to the anode body to which the first conductive polymer adheres by bringing a second treatment liquid containing the second conductive polymer into contact with the anode body. In a third step, after the second step, a third conductive polymer having a thiophene skeleton is adhered to the anode body to which the second conductive polymer adheres by bringing a third treatment liquid containing the third conductive polymer into contact with the anode body.

According to the present disclosure, decrease in capacitance of the electrolytic capacitor due to repeated charging and discharging can be suppressed.

### BRIEF DESCRIPTION OF THE DRAWINGS

FIG. 1 is a schematic cross-sectional view illustrating an electrolytic capacitor according to one exemplary embodiment of the present disclosure; and

FIG. 2 is a schematic cross-sectional view illustrating an enlarged main part of the electrolytic capacitor shown in FIG. 1.

### DETAILED DESCRIPTION OF EMBODIMENT

In the above-described conventional electrolytic capacitor, the conductive polymer layer containing a poly(3,4-ethylenedioxythiophene) (PEDOT) formed on the dielectric layer easily shrinks by repeated charging and discharging, and thus repeated charging and discharging can cause adhesiveness between the conductive polymer layer and the dielectric layer to decrease, thereby decreasing the capacitance of the electrolytic capacitor.

Accordingly, the present disclosure provides an electrolytic capacitor having a superior property in a repeated charging and discharging characteristic, and a production method thereof.

### [Electrolytic Capacitor]

An electrolytic capacitor according to an exemplary embodiment of the present disclosure contains an anode body, a dielectric layer disposed on the anode body, and a solid electrolyte layer disposed on the dielectric layer.

The solid electrolyte layer has, in this order from the dielectric layer, a first conductive polymer layer containing a first conductive polymer having a thiophene skeleton, a second conductive polymer layer containing a second conductive polymer, and a third conductive polymer layer containing a third conductive polymer having a thiophene skeleton. The first conductive polymer layer is formed to cover at least a portion of the dielectric layer, and is in contact with the dielectric layer.

By having the above-described solid electrolyte layer, large capacitance and low equivalent series resistance (ESR) electrolytic capacitors can be obtained. The first conductive polymer layer and the third conductive polymer layer that contain a conductive polymer having a thiophene skeleton have a superior property in conductivity and heat resistance.

The second conductive polymer layer is lower in shrinkage rate at a time of voltage application than the first conductive polymer layer and the third conductive polymer layer. By disposing such a second conductive polymer layer between the first conductive polymer layer and the third conductive polymer layer, shrinkage of the solid electrolyte layer by repeating charging and discharging is reduced. That is, shrinkage of the first conductive polymer layer by repeating charging and discharging is suppressed. And this becomes difficult for the first conductive polymer layer to peel off from the dielectric layer. Therefore, decrease in capacitance of the electrolytic capacitor due to repeated charging and discharging is suppressed.

Here, a shrinkage rate of a conductive polymer layer at a time of voltage application refers to a ratio of decreased size of the conductive polymer layer in a direction of applying voltage when a predetermined voltage is applied to a film of a conductive polymer produced from a solution or dispersion liquid containing a conductive polymer.

The shrinkage rate of a conductive polymer layer at a time of voltage application is measured by, for example, a method below.

A film (with a thickness of 20 μm) of a conductive polymer produced from a solution or dispersion liquid containing a conductive polymer is cut out with a length of 50 mm and a width of 2 mm to obtain a test piece. The test piece is fastened in gold plated chucks so that a voltage is applied in a length direction, and a predetermined DC voltage (10 V) is applied across the chucks. Thereafter, expansion and contraction behaviors are measured with a displacement sensor, so as to calculate the shrinkage rate of the conductive polymer layer at a time of voltage application (the reduction ratio of a size in the length direction of the test piece). For example, the shrinkage rate of a film containing a PEDOT having a thiophene skeleton is approximately 2.0%, and the shrinkage rate of a film containing a polyaniline having an aniline skeleton is approximately 0.3%.

The second conductive polymer preferably has at least one of an aniline skeleton and a pyrrole skeleton, and more preferably has an aniline skeleton. In this case, the second conductive polymer layer has good conductivity, and the shrinkage rate of the second conductive polymer layer at a time of voltage application is particularly low, with which shrinkage of the solid electrolyte layer by repeating charging and discharging is largely reduced.

In view of coverage with respect to the anode body, more preferably, the second conductive polymer has an aniline skeleton.

Generally, when a conductive polymer layer containing a conductive polymer having an aniline skeleton or a pyrrole skeleton formed on a surface of a dielectric layer is heated to a high temperature by a reflow treatment or the like, the conductive polymer layer is deteriorated by the heat thereof, and capacitance of the electrolytic capacitor tends to decrease easily.

On the other hand, when the second conductive polymer layer containing the second conductive polymer having an aniline skeleton or a pyrrole skeleton is formed on the first conductive polymer layer, thermal deterioration of the conductive polymer layer can be suppressed. Since the second conductive polymer layer is formed on a surface of the dielectric layer via the first conductive polymer layer having excellent heat resistance, it is conceivable that the second conductive polymer layer is thermally protected by the first conductive polymer layer.

It is preferable that the second conductive polymer layer is formed near the dielectric layer. In this case, peeling of the conductive polymer layer from the dielectric layer due to expansion and contraction of the first conductive polymer layer accompanying repeating of charging and discharging is further suppressed. When at least a part of the anode body is porous, at least a part of the second conductive polymer layer preferably exists in holes in a surface of the anode body.

Further, preferably, a thickness of the third conductive polymer layer is larger than thicknesses of the first conductive polymer layer and the second conductive polymer layer. By the third conductive polymer layer having a sufficiently large thickness, withstand voltage characteristics of the electrolytic capacitor can be increased.

Preferably, at least a part of the first conductive polymer layer is formed to be in holes of the porous part. Thus, good adhesiveness between the first conductive polymer layer and the dielectric layer can be obtained. Preferably, the first conductive polymer having a thiophene skeleton is a polythiophene or a derivative thereof. Examples of derivatives of the polythiophene include poly(3-methylthiophene), poly(3-ethylthiophene), poly(3,4-dimethylthiophene), poly(3,4-diethylthiophene), poly(3,4-ethylenedioxythiophene). Among others, from the viewpoint of heat resistance, the conductive polymer having a thiophene skeleton is more preferably poly(3,4-ethylenedioxythiophene) (PEDOT).

The first conductive polymer layer may contain a conductive polymer other than the first conductive polymer to an extent that good heat resistance can be ensured.

The second conductive polymer having an aniline skeleton is preferably a polyaniline (PANI) or a derivative thereof. Examples of derivatives of the polyaniline include poly(2-methylaniline), poly(2-ethylaniline), poly(2,6-dimethylaniline).

The second conductive polymer having a pyrrole skeleton is preferably a polypyrrole or a derivative thereof. Examples of derivatives of the polypyrrole include poly(3-methylpyrrole), poly(3-ethylpyrrole) and poly(3,4-dimethylpyrrole).

To an extent that the second conductive polymer layer can obtain an effect of containing the second conductive polymer, the second conductive polymer layer may contain a conductive polymer other than the second conductive polymer.

As the third conductive polymer having a thiophene skeleton, those exemplified for the first conductive polymer can be used. The third conductive polymer may have a molecular structure that is the same as or different from that of the first conductive polymer. The third conductive polymer layer may contain a conductive polymer other than the third conductive polymer.

Hereinafter, a configuration of the electrolytic capacitor will be described in more detail.

### (Anode Body)

A conductive material having a large surface area can be used as the anode body. Examples of the conductive material include a valve metal, an alloy containing a valve metal, and a compound containing a valve metal. One of these materials can be used alone, or two or more of these materials can be used in combination. As the valve metal, for example, aluminum, tantalum, niobium, or titanium is preferably used. The anode body having a porous surface can be obtained by, for example, roughening a surface of a base material (such as a foil-like or plate-like base material) formed of a conductive material by etching or the like. Further, the anode body may be a molded body of particles of a conductive material or a sintered body thereof. Incidentally, the sintered body has a porous structure. That is, when the anode body is a sintered body, the whole anode body can be porous.

### (Dielectric Layer)

The dielectric layer is formed by anodizing, through an anodizing treatment or the like, the conductive material on a surface of the anode body. As a result of anodizing, the dielectric layer contains an oxide of the conductive material (particularly a valve metal). For example, when tantalum is used as the valve metal, the dielectric layer includes Ta₂O₅, and when aluminum is used as the valve metal, the dielectric layer includes Al₂O₃. Note that dielectric layer 3 is not limited to these examples, and any layer is acceptable as the dielectric layer as long as the layer functions as a dielectric body.

When a surface of the anode body is porous, the dielectric layer is formed along the surface of the anode body (the surface including inner walls of holes or pits of the anode body).

### (Solid Electrolyte Layer)

Hereinafter, items common to conductive polymer layers constituting the solid electrolyte layer will be described.

A weight average molecular weight of the conductive polymer is not particularly limited, and ranges, for example, from 1,000 to 1,000,000, inclusive.

The conductive polymer can be obtained by, for example, polymerizing a precursor of the conductive polymer. Examples of the precursor of the conductive polymer include a monomer that constitutes the conductive polymer and/or an oligomer in which some monomers are linked to each other. As a polymerization method, both chemical oxidation polymerization and electrolytic oxidation polymerization can be employed.

The conductive polymer layer may further contain a dopant. In the conductive polymer layer, the dopant may be contained in a state of being doped into the conductive polymer, or may be contained in a state of being bonded to the conductive polymer. The conductive polymer that is bonded to or doped with the dopant can be obtained by polymerizing a precursor of the conductive polymer under existence of the dopant.

As the dopant, one having an anionic group such as a sulfonate group, a carboxy group, a phosphate group (—O—P(═O)(—OH)₂), and/or a phosphonate group (—P(═O)(—OH)₂) is used. The dopant may have one anionic group, or two or more anionic groups. As the anionic group, the sulfonate group is preferred, and a combination of the sulfonate group with an anionic group other than the sulfonate group is also acceptable. The dopant may be a low molecular weight dopant or a high molecular weight dopant. The conductive polymer layer may contain only one dopant, or two or more dopants.

Examples of the low molecular weight dopant include alkylbenzenesulfonic acids such as benzenesulfonic acid and p-toluenesulfonic acid, naphthalenesulfonic acid, and anthraquinonesulfonic acid.

Examples of the high molecular weight dopant include a homopolymer of a monomer having a sulfonate group, a copolymer of a monomer having a sulfonate group and another monomer, and a sulfonated phenolic resin. Examples of the monomer having a sulfonate group include styrenesulfonic acid, vinylsulfonic acid, allylsulfonic acid, 2-acrylamido-2-methylpropanesulfonic acid, and isoprenesulfonic acid. As other monomers, aromatic dicarboxylic acids such as phthalic acid, isophthalic acid and terephthalic acid are preferable. Further, an example of other monomers is acrylic acid or the like. Specifically, an example of the polymer dopant is polystyrene sulfonic acid (PSS).

A weight-average molecular weight of the polymer dopant is, for example, from 1,000 to 1,000,000, inclusive. Use of a polymer dopant having such a molecular weight easily facilitates reduction of ESR.

A ratio of the dopant contained in the conductive polymer layer is preferably from 10 parts by mass to 1,000 parts by mass, inclusive, with respect to 100 parts by mass of the conductive polymer.

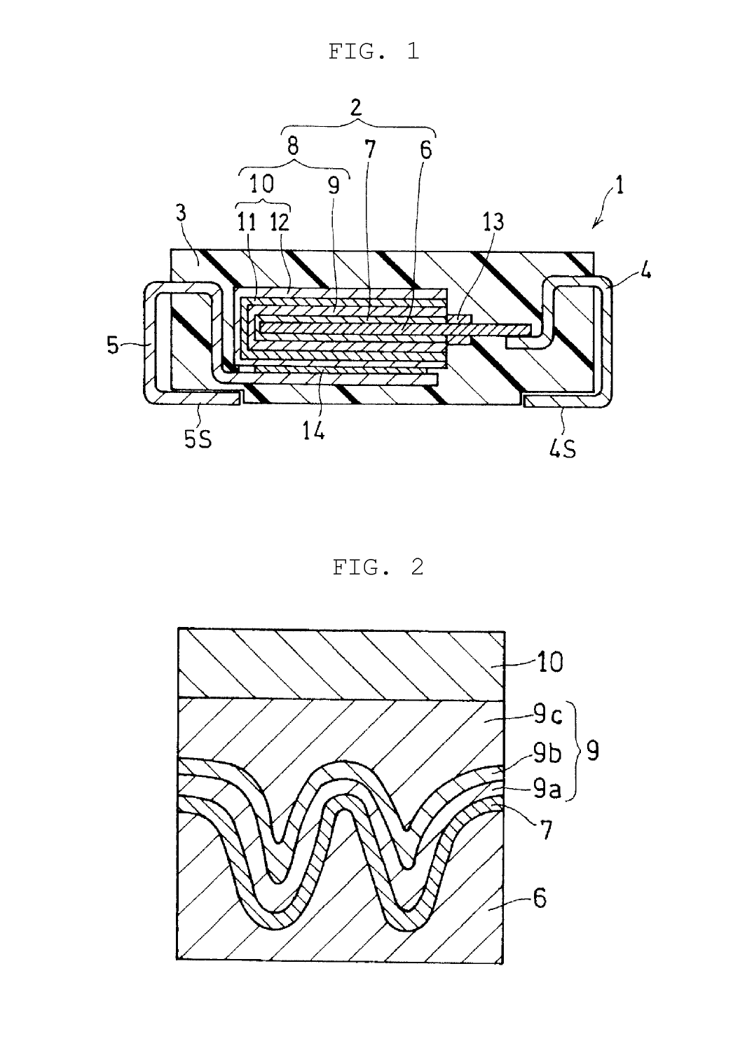

FIG. 1 is a cross-sectional view schematically illustrating a configuration of an electrolytic capacitor according to one exemplary embodiment of the present disclosure. As shown in FIG. 1, electrolytic capacitor 1 includes capacitor element 2, resin sealing material 3 that seals capacitor element 2, and anode terminal 4 and cathode terminal 5 that are at least partially exposed to the outside of resin sealing material 3. Anode terminal 4 and cathode terminal 5 can be constituted of, for example, a material such as copper or copper alloy. Resin sealing material 3 has an outer shape that is a substantially rectangular parallelepiped, and electrolytic capacitor 1 also has an outer shape that is a substantially rectangular parallelepiped. As a material of resin sealing material 3, for example, an epoxy resin can be used.

Capacitor element 2 includes anode body 6, dielectric layer 7 covering anode body 6, and cathode part 8 covering dielectric layer 7. Cathode part 8 includes solid electrolyte layer 9 covering dielectric layer 7 and cathode layer 10 covering solid electrolyte layer 9. Cathode layer 10 includes carbon layer 11 as a cathode extraction layer, and silver paste layer 12.

Anode body 6 includes an area that faces cathode part 8 and an area that does not face cathode part 8. On a part adjacent to cathode part 8, which is in an area of anode body 6 that does not face cathode part 8, insulating separation layer 13 is formed so as to zonally cover a surface of anode body 6. And insulating separation layer 13 restricts contact between cathode part 8 and anode body 6. Another part in the area of anode body 6 that does not oppose cathode part 8 is electrically connected to anode terminal 4 by welding. Cathode terminal 5 is electrically connected to cathode part 8 via adhesive layer 14 made of a conductive adhesive.

As anode body 6, a base material (such as a foil-like or plate-like base material) made of a conductive material whose surface is roughened is used. For example, an aluminum foil whose surface is roughened by etching is used as anode body 6. Dielectric layer 7 contains, for example, an aluminum oxide such as Al₂O₃.

Main face 4S of anode terminal 4 and main face 5S of cathode terminal 5 are exposed from the same face of resin sealing material 12. This exposure face is used for soldering connection with a substrate (not shown) on which electrolytic capacitor 1 is to be mounted.

It is sufficient if carbon layer 11 has conductivity, and carbon layer 11 can be configured, for example, by using a conductive carbon material such as graphite. For silver paste layer 12, for example, there can be used a composition containing a silver powder and a binder resin (such as an epoxy resin). A configuration of cathode layer 10 is not limited to this example, and it is sufficient if cathode layer 10 has a current collection function.

As shown in FIG. 2, solid electrolyte layer 9 includes, in this order from dielectric layer 7, first conductive polymer layer 9a containing a first conductive polymer having a thiophene skeleton, second conductive polymer layer 9b containing a second conductive polymer having an aniline skeleton or a pyrrole skeleton, and third conductive polymer layer 9c containing a third conductive polymer having a thiophene skeleton. Second conductive polymer layer 9b is lower in shrinkage rate at a time of voltage application than first conductive polymer layer 9a and third conductive polymer layer 9c. Examples of the second conductive polymer contained in such second conductive polymer layer 9b include conductive polymers having an aniline skeleton or a pyrrole skeleton.

First conductive polymer layer 9a is formed so as to cover dielectric layer 7, second conductive polymer layer 9b is formed so as to cover first conductive polymer layer 9a, and third conductive polymer layer 9c is formed so as to cover second conductive polymer layer 9b. Note that first conductive polymer layer 9a and second conductive polymer layer 9b do not necessarily cover whole (whole surface of) dielectric layer 7, and it is sufficient if first conductive polymer layer 9a and second conductive polymer layer 9b are formed to cover at least a part of dielectric layer 7.

Dielectric layer 7 is formed along a surface (a surface including inner walls of holes) of anode body 6. A surface of dielectric layer 7 is formed to have an irregular shape corresponding to a shape of the surface of anode body 6, as shown in FIG. 2. In order to further suppress peeling of conductive polymer layer 9 from dielectric layer 7 by shrinkage of first conductive polymer layer 9a due to repeating of charging and discharging, not only first conductive polymer layer 9a but also second conductive polymer layer 9b are preferably formed to fill such irregularities of dielectric layer 7.

The electrolytic capacitor of the present disclosure is not limited to the electrolytic capacitor having the structure described above, and can be various electrolytic capacitors. Specifically, the present disclosure can also be applied to, for example, a wound electrolytic capacitor and an electrolytic capacitor including a metal powder sintered body as the anode body.

### [Production Method of Electrolytic Capacitor]

A production method of an electrolytic capacitor includes a step (first step) of forming a first conductive polymer layer including a first conductive polymer having a thiophene skeleton on a dielectric layer of an anode body provided with the dielectric layer, a step (second step) of forming a second conductive polymer layer including a second conductive polymer on the first conductive polymer layer, and a step (third step) of forming a third conductive polymer layer including a third conductive polymer having a thiophene skeleton on the second conductive polymer layer. The second conductive polymer layer is lower in shrinkage rate at a time of voltage application than the first conductive polymer layer and the third conductive polymer layer. The second conductive polymer preferably has an aniline skeleton or a pyrrole skeleton.

The production method of the electrolytic capacitor may include a step of preparing an anode body, and a step of forming a dielectric layer on the anode body prior to the first step. The production method may further include a step of forming a cathode layer.

Hereinafter, the steps will be described in more detail.

### (Step of Preparing Anode Body)

In this step, the anode body is formed by a publicly known method according to a kind of the anode body.

The anode body can be prepared by, for example, roughening a surface of a foil-like or plate-like substrate formed from a conductive material. It is sufficient that roughening can form irregularities on the surface of the substrate. Roughening may be conducted, for example, by subjecting the surface of the substrate to etching (for example, electrolytic etching), or by depositing particles of a conductive material on the surface of the substrate using a gas phase method such as vapor deposition.

In addition, a valve metal powder is prepared, and molded into a desired shape (for example, a block shape) while a rod-like anode lead is embedded in the powder at one end of the anode lead in a longitudinal direction, so as to obtain a molded body. This molded body may be sintered to form an anode body of porous structure in which an anode lead is embedded at one end of the anode lead.

### (Step of Forming Dielectric Layer)

In this step, a dielectric layer is formed on the anode body. The dielectric layer is formed by anodizing the anode body through an anodizing treatment or the like. The anodization can be performed by a publicly known method, for example, an anodizing treatment. The anodizing treatment can be performed by, for example, immersing the anode body in an anodizing solution to impregnate a surface of the anode body, on which the dielectric layer is formed, with the anodizing solution and applying a voltage between the anode body as an anode and a cathode immersed in the anodizing solution. It is preferable to use, for example, a phosphoric acid aqueous solution as the anodizing solution.

### (Step of Forming First Conductive Polymer Layer)

In the first step, the first conductive polymer layer having a thiophene skeleton is formed so as to cover at least a part of the dielectric layer. In the first step, a first treatment liquid containing a first conductive polymer is brought into contact with the anode body having the dielectric layer formed on the anode body. In this case, a first conductive polymer layer having dense film quality can be formed. The first treatment liquid may further contain other components such as dopant.

A step of forming the first conductive polymer layer includes, for example, step a of immersing the anode body with the dielectric layer formed thereon in the first treatment liquid or applying or dropping the first treatment liquid on the anode body with the dielectric layer formed thereon, and thereafter drying the first treatment liquid. Step a may be performed several times.

The first treatment liquid is, for example, a dispersion liquid or a solution of the first conductive polymer. An average particle size of particles of the first conductive polymer existing in the first treatment liquid ranges, for example, from 5 nm to 800 nm, inclusive. The average particle size of the conductive polymer can be obtained from, for example, particle size distribution by a dynamic light scattering method.

Since the first conductive polymer having a thiophene skeleton is used and damage to the dielectric layer is suppressed, preferably, a dispersion liquid of the first conductive polymer is used for forming the first conductive polymer layer.

Examples of the dispersion medium (solvent) used for the dispersion liquid or solution of the first conductive polymer include water, organic solvent, and mixtures thereof. Examples of the organic solvent include monohydric alcohols such as methanol, ethanol and propanol, polyhydric alcohols such as ethylene glycol and glycerin, and aprotic polar solvents such as N, N-dimethylformamide, dimethylsulfoxide, acetonitrile, acetone, and benzonitrile.

### (Step of Forming Second Conductive Polymer Layer)

In the second step, the second conductive polymer layer having an aniline skeleton or a pyrrole skeleton is formed so as to cover at least a part of the first conductive polymer layer. In the second step, a second treatment liquid containing a second conductive polymer is brought into contact with the anode body after the first step. In this case, a second conductive polymer layer having dense film quality can be formed. The second treatment liquid may further contain other components such as dopant.

When the second treatment liquid containing the second conductive polymer having an aniline skeleton is used, coverage with respect to the anode body of the second conductive polymer layer to be formed is higher than when the second treatment liquid containing the second conductive polymer having a pyrrole skeleton is used. Thus, more preferably, the second treatment liquid contains the second conductive polymer having an aniline skeleton.

In the second step, when at least a part of the anode body is porous, preferably, at least a part of the second treatment liquid enters into holes in a surface of the anode body. At least a part of the second conductive polymer layer can be formed in the holes in the surface of the anode body.

A step of forming the second conductive polymer layer includes, for example, step b of immersing the first conductive polymer layer in the second treatment liquid or applying or dropping the second treatment liquid on the first conductive polymer layer, and thereafter drying the second treatment liquid. Step b may be performed several times.

The second treatment liquid is, for example, a dispersion liquid or a solution of the second conductive polymer. An average particle size of particles of the second conductive polymer existing in the second treatment liquid is, for example, less than or equal to 400 nm.

Because the second conductive polymer has an aniline skeleton or a pyrrole skeleton, preferably, a dispersion liquid of the second conductive polymer is used for forming the second conductive polymer layer. When the solution of the second conductive polymer is used, at least a part of the second conductive polymer layer can be easily formed in holes in a surface of the anode body.

As a dispersion medium (solvent) used for the dispersion liquid or solution of the second conductive polymer, the one exemplified by the dispersion medium or solvent of the first conductive polymer can be used.

### (Step of Forming Third Conductive Polymer Layer)

In the third step, the third conductive polymer layer is formed so as to cover at least a part of the second conductive polymer layer. In the third step, a third treatment liquid containing a third conductive polymer is brought into contact with the anode body after the second step. In this case, a third conductive polymer layer having dense film quality can be formed, and excellent withstand voltage characteristics are easily obtained. The third treatment liquid may further contain other components such as dopant.

A step of forming the third conductive polymer layer includes, for example, step c of immersing the second conductive polymer layer obtained in the second step in the third treatment liquid or applying or dropping the third treatment liquid on the second conductive polymer layer obtained in the second step, and thereafter drying the third treatment liquid. Step c may be performed several times.

The third treatment liquid is, for example, a dispersion liquid or a solution of the third conductive polymer. An average particle size of particles of the third conductive polymer existing in the third treatment liquid ranges, for example, from 5 nm to 800 nm, inclusive.

Since the third conductive polymer has a thiophene skeleton, preferably, a dispersion liquid of the third conductive polymer is used for forming the third conductive polymer layer. In order to form a solid electrolyte layer (third conductive polymer layer) with a sufficient thickness, an average particle size of particles of the third conductive polymer is preferably larger than the average particle size of particles of the first conductive polymer and the second conductive polymer.

Further, in order to form the third conductive polymer layer with a sufficient thickness, as the third treatment liquid, one having a high solid content solution as compared to the first treatment liquid and the second treatment liquid may be used, and the number of times of step c in which the third treatment liquid is used may be increased.

Further, when the average particle size of particles of the third conductive polymer is nearly equal to the average particle size of particles of the first conductive polymer, a fourth treatment liquid containing particles of a fourth conductive polymer having an average particle size greater than the average particle size of particles of the third conductive polymer may be used to form a fourth conductive polymer layer on the third conductive polymer layer. In this case, the solid electrolyte layer (the fourth conductive polymer layer) can be formed with a sufficient thickness. The fourth conductive polymer has a thiophene skeleton, and has a molecular structure that may be the same as or different from a molecular structure of the third conductive polymer.

A step of forming the fourth conductive polymer layer includes, for example, step d of immersing the third conductive polymer layer obtained in the third step in the fourth treatment liquid or applying or dropping the fourth treatment liquid on the third conductive polymer layer obtained in the third step, and thereafter drying the fourth treatment liquid. Step d may be performed several times.

The fourth treatment liquid is, for example, a dispersion liquid or a solution of the fourth conductive polymer. An average particle size of particles of the fourth conductive polymer existing in the fourth treatment liquid ranges, for example, from 5 nm to 800 nm, inclusive. Since the fourth conductive polymer has a thiophene skeleton, a dispersion liquid of the fourth conductive polymer is preferably used for forming the fourth conductive polymer layer.

As a dispersion medium (solvent) used for the dispersion liquid or solution of the third conductive polymer and the fourth conductive polymer, the one exemplified by the dispersion medium (solvent) of the first conductive polymer can be used.

### (Step of Forming Cathode Layer)

In this step, a cathode layer is formed by sequentially stacking a carbon layer and a silver paste layer on a surface of the anode body obtained in the second step.

### EXAMPLES

Hereinafter, the present disclosure will be specifically described based on Examples and Comparative Examples. The present disclosure, however, is not limited to the examples below.

### Example 1

Electrolytic capacitor 1 shown in FIG. 1 was prepared in the manner described below, and characteristics of the electrolytic capacitor were evaluated.

### (1) Step of Preparing Anode Body

An aluminum foil (with a thickness of 100 μm) was prepared, and etching was performed on a surface of the aluminum foil, so as to obtain anode body 6. An insulating resist tape (separation layer 13) was attached so as to zonally cover a surface of anode body 6.

### (2) Step of Forming Dielectric Layer

Anode body 6 was immersed in a phosphate acid solution in a concentration of 0.3% by mass (at a liquid temperature of 70° C.), and a DC voltage of 70 V was applied for 20 minutes, thereby forming a dielectric layer 7 containing an aluminum oxide (Al₂O₃) on a surface of anode body 6.

### (3) Step of Forming First Conductive Polymer Layer

Anode body 6 with dielectric layer 7 formed thereon was immersed in a first treatment liquid (PEDOT/PSS aqueous dispersion liquid, in a concentration of 2% by mass, with an average particle size of 400 nm of PEDOT/PSS particles), and thereafter a step of drying at 120° C. for 10 to 30 minutes was repeated twice, thereby forming first conductive polymer layer 9a.

### (4) Step of Forming Second Conductive Polymer Layer

First conductive polymer layer 9a (the anode body having a surface on which the dielectric layer and the first conductive polymer layer were sequentially formed) was immersed in a second treatment liquid (PANI aqueous solution, in a concentration of 5% by mass), and thereafter a step of drying at 190° C. for 2 to 5 minutes was performed once, thereby forming second conductive polymer layer 9b.

### (5) Step of Forming Third Conductive Polymer Layer

Second conductive polymer layer 9b (the anode body having a surface on which the dielectric layer, the first conductive polymer layer, and the second conductive polymer layer were sequentially formed) was immersed in a third treatment liquid (PEDOT/PSS aqueous dispersion liquid, in a concentration of 4% by mass, with an average particle size of 600 nm of PEDOT/PSS particles), and thereafter a step of drying at 120° C. for 10 to 30 minutes was repeated four times, thereby forming third conductive polymer layer 9c.

### (6) Step of Forming Cathode Layer

On third conductive polymer layer 9c (the anode body having a surface on which the dielectric layer, the first conductive polymer layer, the second conductive polymer layer, and the third conductive polymer layer were sequentially formed), a dispersion liquid with graphite particles dispersed in water was applied and subsequently dried in the atmosphere, thereby forming carbon layer 11 on a surface of the third conductive polymer layer.

Then, a silver paste containing silver particles and a binder resin (epoxy resin) was applied onto a surface of carbon layer 11, and thereafter, the binder resin was cured by heating to form silver paste layer 12. In this manner, cathode layer 10 constituted of carbon layer 11 and silver paste layer 12 was formed.

Thus, capacitor element 2 was obtained.

### (7) Assembling of Electrolytic Capacitor

Anode terminal 4, cathode terminal 5, and adhesive layer 14 were disposed on obtained capacitor element 2 and were sealed with resin sealing material 3, thereby producing an electrolytic capacitor.

### Example 2

An electrolytic capacitor was produced in a manner similar to Example 1 except that a solid electrolyte layer was formed in a procedure below.

### (1) Step of Forming First Conductive Polymer Layer

An anode body on which a dielectric layer is formed was immersed in a first treatment liquid (PEDOT/PSS aqueous dispersion liquid, in a concentration of 2% by mass, with an average particle size of 400 nm of PEDOT/PSS particles), and thereafter a step of drying at 120° C. for 10 to 30 minutes was repeated twice, thereby forming a first conductive polymer layer.

### (2) Step of Forming Second Conductive Polymer Layer

The first conductive polymer layer (the anode body having a surface on which the dielectric layer and the first conductive polymer layer were sequentially formed) was immersed in a second treatment liquid (PANT aqueous solution, in a concentration of 5% by mass), and thereafter a step of drying at 190° C. for 2 to 5 minutes was performed once, thereby forming a second conductive polymer layer.

### (3) Step of Forming Third Conductive Polymer Layer

The second conductive polymer layer (the anode body having a surface on which the dielectric layer, the first conductive polymer layer, and the second conductive polymer layer were sequentially formed) was immersed in a third treatment liquid (PEDOT/PSS aqueous dispersion liquid, in a concentration of 2% by mass, with an average particle size of 400 nm of PEDOT/PSS particles), and thereafter a step of drying at 120° C. for 10 to 30 minutes was performed once, thereby forming a third conductive polymer layer.

### (4) Step of Forming Fourth Conductive Polymer Layer

The third conductive polymer layer (the anode body having a surface on which the dielectric layer, the first conductive polymer layer, the second conductive polymer layer, and the third conductive polymer layer were sequentially formed) was immersed in a third treatment liquid (PEDOT/PSS aqueous dispersion liquid, in a concentration of 4% by mass, with an average particle size of 600 nm of PEDOT/PSS particles), and thereafter a step of drying at 120° C. for 10 to 30 minutes was performed four times, thereby forming a fourth conductive polymer layer.

### Comparative Example 1

An electrolytic capacitor was produced by a method similar to Example 1 except using the second treatment liquid instead of the first treatment liquid in the formation step of the first conductive polymer layer, and using the first treatment liquid instead of the second treatment liquid in the formation step of the second conductive polymer layer.

### Comparative Example 2

An electrolytic capacitor was produced by a method similar to Example 1 except using the first treatment liquid instead of the second treatment liquid in the formation step of the second conductive polymer layer, and using the second treatment liquid instead of the third treatment liquid in the formation step of the third conductive polymer layer.

### Comparative Example 3

An electrolytic capacitor was produced by a method similar to Example 1 except using the first treatment liquid instead of the second treatment liquid in the formation step of the second conductive polymer layer.

### [Evaluation]

### (1) Measurement of Initial Capacitance

Under an environment at 25° C., an initial electrostatic capacity (capacitance A) at a frequency of 120 Hz was measured for the electrolytic capacitor using an LCR meter for four-terminal measurement.

Capacitance A of each electrolytic capacitor was expressed as a relative value (index) given that capacitance A of Comparative Example 3 is 100.

(2) Measurement of Reduction Rate of Capacitance after Repeated Charging and Discharging

An electrolytic capacitor was subjected to charging for 5 seconds and discharging for 5 seconds alternately 10,000 times under an environment at 25° C. and under a voltage that is 1.25 times the rated voltage. Thereafter, capacitance B was measured in a manner similar to the above measurement (1).

Then, the reduction rate of capacitance (%) after repeated charging and discharging was obtained with the following formula.

Reduction rate (%) of capacitance after repeated charging and discharging=(capacitance A−capacitance B)/capacitance A×100.

(3) Measurement of Reduction Rate of Capacitance after Heating at High Temperatures

The electrolytic capacitor was heated at 260° C. for three minutes. Thereafter, capacitance C was measured in a manner similar to the above measurement (1).

Then, the reduction rate of capacitance after heating at high temperatures was obtained with the following formula.

Reduction rate (%) of capacitance after heating at high temperatures=(capacitance A−capacitance C)/capacitance A×100.

Table 1 shows evaluation results.

TABLE 1

| | Solid electrolyte layer | | | |
|---|---|---|---|---|
| | First | Second | Third | Fourth |
| | conductive | conductive | conductive | conductive |
| | polymer | polymer | polymer | polymer |
| | layer | layer | layer | layer |
| Example 1 | PEDOT/PSS | PANI | PEDOT/PSS | — |
| Example 2 | PEDOT/PSS | PANI | PEDOT/PSS | PEDOT/PSS |
| Comparative | PANI | PEDOT/PSS | PEDOT/PSS | — |
| example 1 | | | | |
| Comparative | PEDOT/PSS | PEDOT/PSS | PANI | — |
| example 2 | | | | |
| Comparative | PEDOT/PSS | PEDOT/PSS | PEDOT/PSS | — |
| example 3 | | | | |

| | Evaluation | | |
|---|---|---|---|
| | | Reduction rate | Reduction rate |
| | | of capacitance | of capacitance |
| | | after repeated | after heated |
| | Initial | charging and | at high |
| | capacitance | discharging | temperatures |
| | (Index) | (%) | (%) |
| Example 1 | 103 | 10.2 | 1.2 |
| Example 2 | 106 | 8.3 | 1.2 |
| Comparative | 91 | 11.8 | 4.5 |
| example 1 | | | |
| Comparative | 102 | 71.6 | 1.0 |
| example 2 | | | |
| Comparative | 100 | 77.4 | 1.0 |
| example 3 | | | |

As shown in Table 1, in Examples 1 and 2, the capacitance was high and the reduction rate of capacitance after repeated charging and discharging was small, comparted to Comparative Examples 1 to 3.

In Example 2, the reduction rate of capacitance after repeated charging and discharging was small as comparted to Comparative Example 1. This result is conceivably due to that, in Example 2, the second conductive polymer layer was formed closer to the dielectric layer as compared to Comparative Example 1.

In Comparative Example 1, the initial capacitance was low, and the reduction rate of capacitance after repeated charging and discharging increased as compared to Example 1. This result is conceivably due to that in the case of Comparative Example 1 in which the first conductive polymer layer contains PANI, as compared to Example 1 in which the second conductive polymer layer contains PANI, the conductive polymer layer containing PANI undergoes the heating and drying step many times. Thus, the degree of deterioration of PANI under influence of heat in the production process became large, and conductivity decreased. Further, in Comparative Example 1, the reduction rate of capacitance after heating at high temperatures increased as compared to Example 1. This result is conceivably due to that the first conductive polymer layer containing PANI formed on the dielectric layer was deteriorated by heat.

In Comparative Examples 2 and 3, the capacitance decreased largely after repeated charging and discharging. This result is conceivably due to that the effect of suppressing peeling off of the first conductive polymer layer from the dielectric layer due to repeating of charging and discharging was not obtained because, in Comparative Example 2, the third conductive polymer layer containing PANI exist away from the dielectric layer, and in Comparative Example 3, the solid electrolyte layer has no layer containing PANI.

The electrolytic capacitor according to the present disclosure can be used for various uses in which the high capacitance is required even after charging and discharging are repeated.

What is claimed is:

1. An electrolytic capacitor comprising:
an anode body;
a dielectric layer disposed on the anode body; and
a solid electrolyte layer disposed on the dielectric layer, wherein:
the solid electrolyte layer includes a first conductive polymer layer, a second conductive polymer layer, and a third conductive polymer layer that are disposed in this order from the dielectric layer,
the first conductive polymer layer contains a first conductive polymer having a thiophene skeleton,
the second conductive polymer layer contains a second conductive polymer having at least one of an aniline skeleton and a pyrrole skeleton, and
the third conductive polymer layer contains a third conductive polymer having a thiophene skeleton.

2. An electrolytic capacitor comprising:
an anode body;
a dielectric layer disposed on the anode body; and
a solid electrolyte layer disposed on the dielectric layer, wherein:
the solid electrolyte layer includes a first conductive polymer layer, a second conductive polymer layer, and a third conductive polymer layer that are disposed in this order from the dielectric layer,
the first conductive polymer layer contains a first conductive polymer having a thiophene skeleton,
the second conductive polymer layer contains a second conductive polymer,
the third conductive polymer layer contains a third conductive polymer having a thiophene skeleton, and
the second conductive polymer layer is lower in shrinkage rate at a time of voltage application than the first conductive polymer layer and the third conductive polymer layer.

3. The electrolytic capacitor according to claim 1, wherein:
at least a part of the anode body is porous, and
at least a part of the second conductive polymer layer exists in holes of the anode body.

4. The electrolytic capacitor according to claim 2, wherein
at least a part of the anode body is porous, and
at least a part of the second conductive polymer layer exists in holes of the anode body.

5. A method for producing an electrolytic capacitor, the method comprising:
a first step of making a first conductive polymer having a thiophene skeleton adhere to an anode body on which a dielectric layer is formed by bringing a first treatment liquid containing the first conductive polymer into contact with the anode body;
after the first step, a second step of making a second conductive polymer having at least one of an aniline skeleton and a pyrrole skeleton adhere to the anode body to which the first conductive polymer adheres by bringing a second treatment liquid containing the second conductive polymer into contact with the anode body; and
after the second step, a third step of making a third conductive polymer having a thiophene skeleton adhere to the anode body to which the second conductive polymer adheres by bringing a third treatment liquid containing the third conductive polymer into contact with the anode body.

6. The method according to claim 5, wherein:
the first treatment liquid is a dispersion liquid of the first conductive polymer, and
the third treatment liquid is a dispersion liquid of the third conductive polymer.

7. The method according to claim 5, wherein the second treatment liquid is a solution of the second conductive polymer.

8. The method according to claim 5, wherein:
at least a part of the anode body is porous, and
in the second step, at least a part of the second treatment liquid enters into holes in a surface of the anode body.
